(19) United States
(12) Patent Application Publication
(10) Pub. No.: US 2015/0263776 A1
(43) Pub. Date: Sep. 17, 2015

(54) PROTECTIVE COVER FOR A DEVICE

(71) Applicant: Hewlett-Packard Development Company, L.P., Fort Collins, CO (US)

(72) Inventors: Vincent Kenya Shyu, Houston, TX (US); Eric Chen, Houston, TX (US); Rudy Widiaman, The Woodlands, TX (US)

(73) Assignee: Hewlett-Packard Development Company, L.P., Fort Collins, CO (US)

(21) Appl. No.: 14/205,338

(22) Filed: Mar. 11, 2014

(51) Int. Cl. H04B 1/3888; A45C 13/00; A45C 11/00

(52) U.S. Cl. CPC H04B 1/3888; A45C 11/00; A45C 13/002; A45C 2011/003

(57) ABSTRACT

Examples disclosed herein provide a protective cover for a portable computing device. The protective cover can include a first portion including a case for enclosing a back surface and sidewalls of the device. The case can include an opening for exposing a portion of the device comprising a first sidewall and a portion of the back surface adjacent to the first sidewall. The protective cover can include a second portion pivotally connected to the first portion. The second portion can wrap around a second sidewall of the device opposite the first sidewall to protect the display surface of the device when the device is not in use.

### BACKGROUND

The emergence and popularity of mobile computing has made portable computing devices, due to their compact design and light weight, a staple in today's marketplace. Tablet computers are examples of portable computing devices that are widely used. Tablet computers generally employ a touchscreen on a display surface of the tablet that may be used for both viewing and input. Users of tablets may interact with the touchscreen via finger or stylus gestures. As an example, an on-screen keyboard may be illustrated on the touchscreen surface for entering characters.

### BRIEF DESCRIPTION OF THE DRAWINGS

FIG. 1 illustrates a protective cover for a portable computing device, according to an example;

FIG. 2A illustrates a rear surface of the protective cover fitted to the portable computing device, according to an example;

FIG. 2B illustrates the portable computing device docked to a docking station, while the device is enclosed by the protective cover, according to an example; and

FIGS. 3A-B provide example illustrations of the protective cover supporting the portable computing device on a horizontal surface at angles suitable for viewing visual content, according to an example.

### DETAILED DESCRIPTION

As the computing power of portable computing devices such as tablet computers continue to increase, users may desire to expand the use of such devices, for example, from solely employing the touchscreen on the display surface of the tablet computer for both viewing and input. As an example, the tablet computer may be docked to a docking station, which may include various ports (e.g., USB, HDMI, etc.) for expanding the use of the tablet computer. Examples include viewing content from the tablet computer on a secondary monitor connected to a video port of the docking station (e.g., HDMI), and connecting the tablet computer to various peripherals via the ports of the docking station (e.g., keyboard, mouse, etc.).

With regards to a keyboard, there may be instances when users may desire to enter characters via an external, physical keyboard, particularly when creating content or typing for a prolonged period of time (e.g., creating a document, spreadsheet, or slides). By providing options in expanding the uses of tablet computers, users of tablet computer may have the flexibility to choose between the portable nature of such devices (e.g., employing the touchscreen on the display surface of the tablet computer for both viewing and input) or the expanded uses that allow users to operate the tablet computer similar to a desktop or notebook computer.

While using a portable computing device such as a tablet computer, it may be desirable to protect the tablet computer via a protective cover. As an example, the protective cover may prevent damage to the tablet computer from accidental drops. The protective cover may be used to cover various portions of the tablet computer, such as the display surface and/or the back surface opposite the display surface. As an example, the protective cover may protect at least the display surface when the tablet computer is not in use. When designing such protective covers, factors that may be considered include at least aesthetics and ease of use. When choosing a protective cover, users may consider the overall appearance of the tablet computer when fitted with the protective cover. With regards to ease of use, users may consider the ease of using the tablet computer while it is fitted to the protective cover. A challenge faced by designers of such protective covers is ensuring an ease in transitioning from the portable use of the tablet computer to expanded uses as described above, all while protecting the tablet computer via the protective cover.

Examples disclosed herein provide a protective cover for a portable computing device such as a tablet computer. The protective cover may allow for users to dock the tablet computer to a docking station while the tablet computer is fitted to the protective cover.

In one example, a protective cover for a portable computing device can include a first portion including a case for enclosing a back surface and sidewalls of the device. The case can include an opening for exposing a portion of the device comprising a first sidewall and a portion of the back surface adjacent to the first sidewall. The protective cover can include a second portion pivotally connected to the first portion. The second portion can wrap around a second sidewall of the device opposite the first sidewall to protect the display surface of the device when the device is not in use.

In another example, a protective cover for a portable computing device can include a first portion including a case for enclosing a back surface and sidewalls of the device. The case can include an opening for exposing a portion of the device comprising a first sidewall and a portion of the back surface extending from the first sidewall. The protective cover can include a second portion pivotally connected to the first portion. The second portion can wrap around a second sidewall of the device opposite the first sidewall to protect the display surface of the device when the device is not in use.

In yet another example, a system can include a portable computing device including a display surface and a back surface opposite the display surface, and a protective cover for the device. The protective cover can include a first portion including a case for enclosing the back surface and sidewalls of the device. The case can include an opening for exposing a portion of the device comprising a first sidewall and a portion of the back surface adjacent to the first sidewall. The protective cover can include a second portion pivotally connected to the first portion. The second portion can wrap around a second sidewall of the device opposite the first sidewall to protect the display surface of the device when the device is not in use.

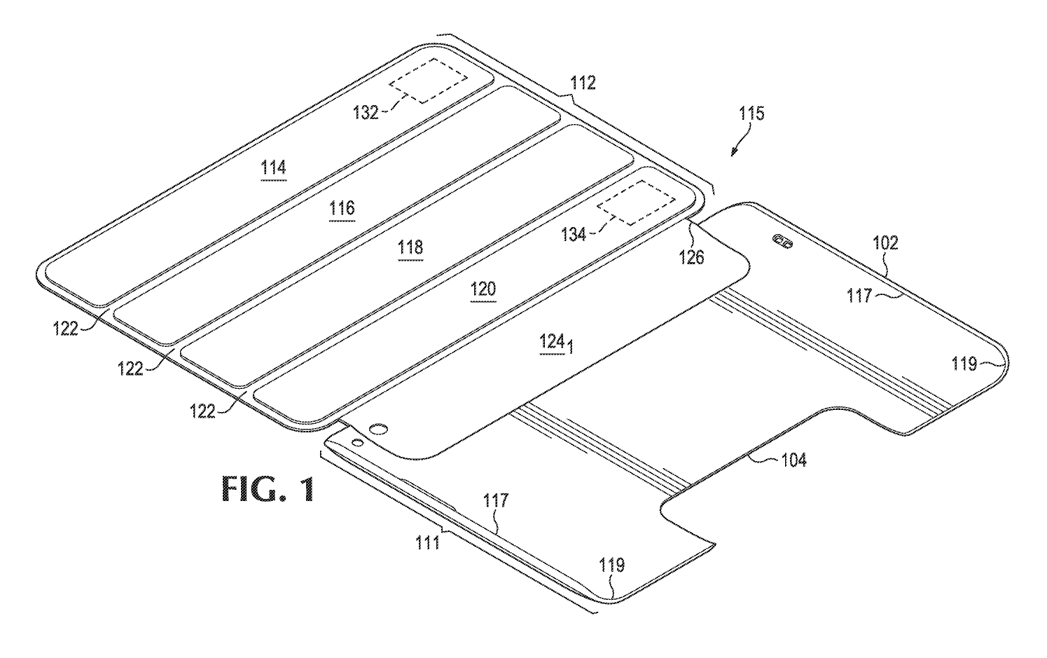

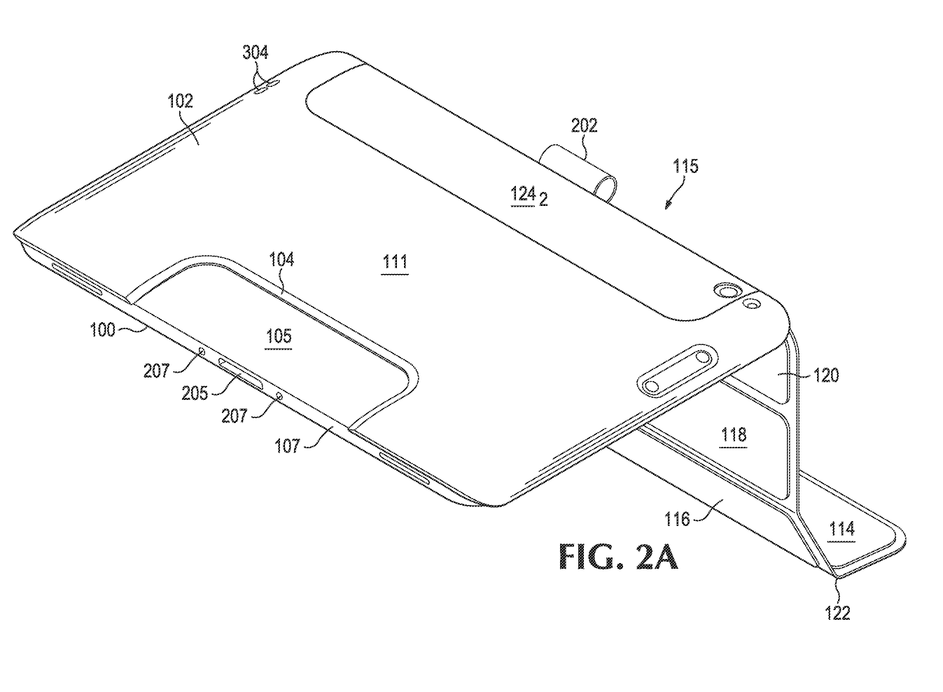

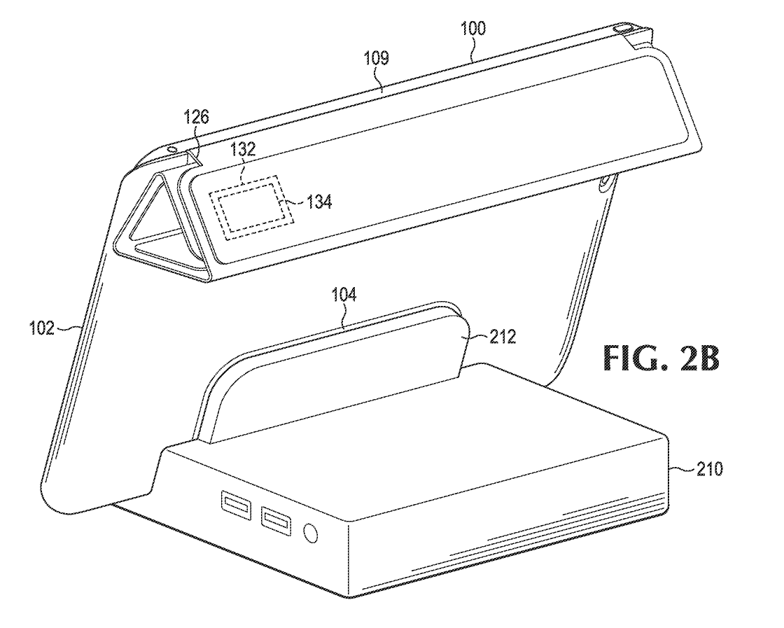

With reference to the figures, FIG. 1 illustrates a protective cover 115 for a portable computing device such as a tablet computer including a display surface and a back surface opposite to the display surface, according to an example. The protective cover 115 includes a first portion 111 and a second portion 112 pivotally connected to the first portion 111. The first portion 111 may be used to protect at least the back surface of the tablet, and the second portion 112 may be used to protect at the display surface of the tablet when the tablet is not in use. As an example, the first portion 111 may be attached to the second portion 112 by various methods (e.g., using an adhesive or ultrasonic bonding). With regards to ultrasonic bonding, the second portion 112 may include a flap 124₁ to be bonded to the first portion 111. In order to provide a more secure attachment between the portions 111, 112, the second portion 112 may include an additional flap 124₂ to be bonded to a surface of the first portion 111 opposite to the surface bonded to flap 124₁ (e.g., see FIG. 2A)

Referring to FIG. 1, the protective cover 115 may include the first portion 111 and the second portion 112 separated from each other by a folding region 126 (e.g., pivotally or flexibly attached). In this way, the portions 111, 112 may be folded with respect to each other at the folding region 126. As an example, the folding region 126 may be thinner than the portions 111, 112, and composed of a foldable or pliable material. The foldable or pliable material may be a portion of the flaps (e.g., flaps 124₁, 124₂) that are not bonded to the first portion 111 by ultrasonic bonding. The second portion 112 may wrap around a sidewall of the tablet, via the folding region 126, to protect the display surface of the tablet when the tablet is not in use. As an example, the second portion 112 can have a size and shape in accordance with the display surface of the tablet. In addition, the second portion 112 may be one solid segment or divided into multiple segments separated from each other by a folding region.

Referring to FIG. 1, the second portion 112 of the protective cover 115 may include a plurality of independently foldable segments that fold with respect to each other to form a folded state of the second portion 112. As an example, the second portion 112 may include a first segment 114 at a first side of the second portion 112 and a second segment 120 at a second side of the second portion opposite the first side. In addition, the second portion 112 may have segments 116, 118 (e.g., a third segment and fourth segment) disposed between the first segment 114 and the second segment 120. Each segment may be separated from other segments by a folding region 122 (e.g., pivotally or flexibly attached). In this way, the segments 114, 116, 118, 120 may be folded with respect to each other at the folding regions 122. Although the figures illustrate the second portion 112 having four segments, the second portion 112 may have more or less segments. As an example, the second portion 112 may be one solid segment without any folding regions 122.

The second portion 112 may be formed of layers of material attached to one another to form the second portion 112. The layers may each be formed of materials having desired properties. For example, a layer of the second portion 112 that comes in contact with delicate surfaces such as glass (e.g., the display surface of the tablet) can be formed of a soft material (e.g., micro-fiber) that will not mar or otherwise damage the delicate surface. Similarly, a layer that is exposed to the external environment can be formed of a more rugged and durable material such as plastic or leather. As an example, flap 124₁, a continuation of the layer of the second portion 112 that comes in contact with the display surface of the tablet, may be micro-fiber, and flap 124₂, a continuation of the layer of the second portion 112 that is exposed to the external environment, may be plastic or leather.

As mentioned above, the second portion 112 may be partitioned into a number of segments (e.g., segments 114, 116, 118, 120) interspersed with thinner, foldable portions 122. Each of the segments may include one or more inserts disposed therein. The inserts may have various shapes. As an example, the inserts may be shaped to conform to the overall look of the second portion 112 (e.g., the raised rectangular shapes illustrated in each segment). Inserts included in the segments 114, 116, 118, 120 may be composed of a rigid or semi-rigid material in order to provide a level of sturdiness and rigidity while using the protective cover 115 with the tablet. Examples of materials that may be used for the inserts include, but are not limited to, plastics, fiber glass, carbon fiber composites, and metals. Each segment may be separated from other segments by a thinner folding region 122 that is composed of foldable or pliable material.

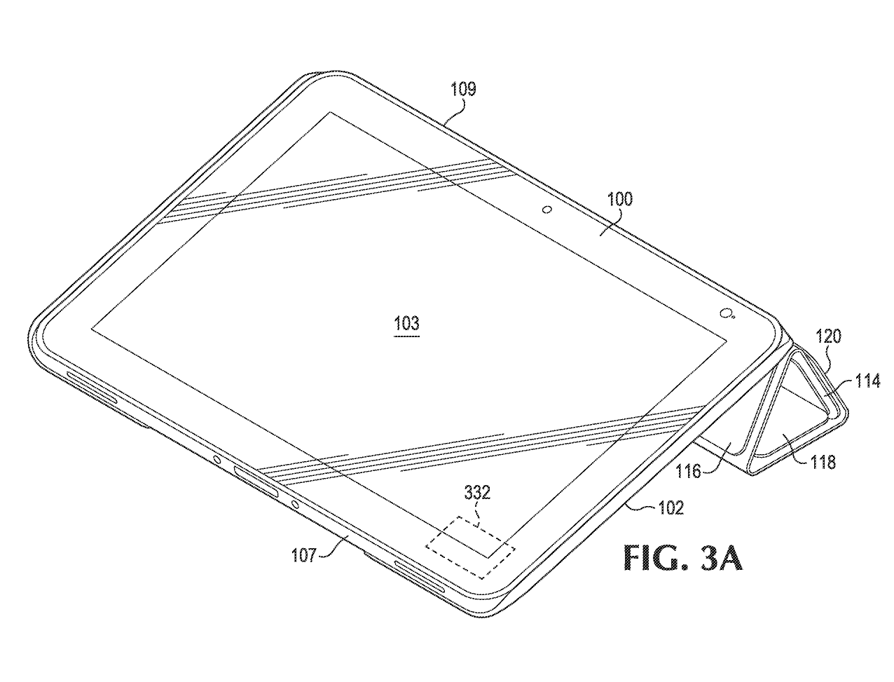

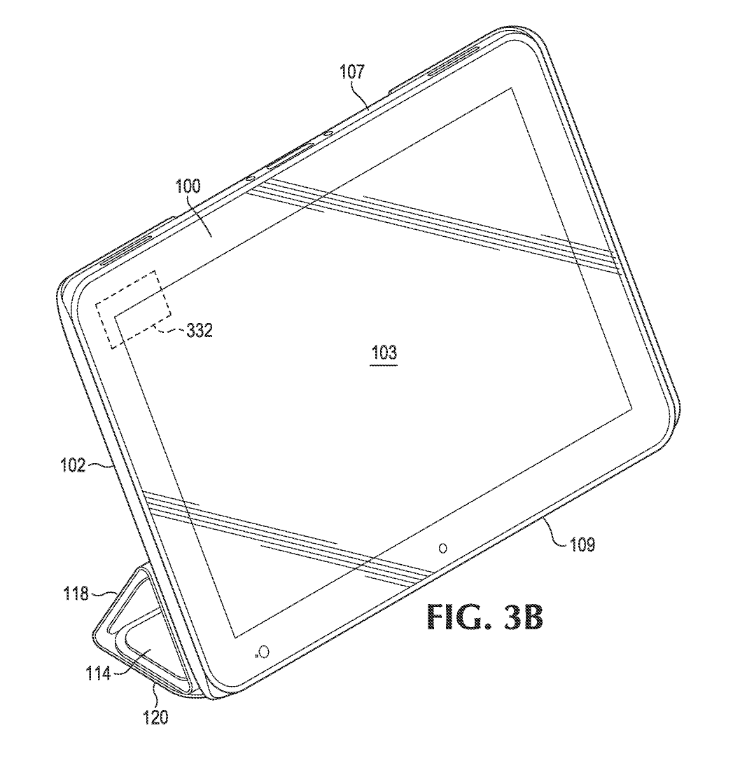

As an example, the folded state of the second portion 112 may include a triangular structure for supporting a tablet fitted to the protective cover 115 at an angle suitable for viewing visual content presented on the display surface of the tablet or as a keyboard support, as will be further described (e.g., see FIGS. 3A-B) Segments of the second portion 112 may include magnetic elements in order to magnetically bound together and form the triangular structure. Referring to FIG. 1, the first segment 114 may include magnetic member 132 to interact with a magnetic member 134 disposed in the second segment 120 when forming the triangular structure, as will be further described.

FIG. 2A illustrates a rear surface of the protective cover 115 fitted to a portable computing device such as a tablet computer 100 including a display surface 103 and a back surface 105 opposite the display surface 103, according to an example. The first portion 111 of the protective cover 115 may include a case 102 for enclosing the back surface 105 and sidewalls of the tablet 100. In between the display surface 103 and the back surface 105, the tablet 100 may include sidewalls around a perimeter of the tablet. As an example, the tablet may include four sidewalls (e.g., a left sidewall, a right sidewall, a top sidewall 109, and a bottom sidewall 107). Although a user may be able to view the tablet in a portrait or landscape orientation, the bottom sidewall 107 may refer to the same sidewall of the tablet. As an example, the case 102 may include a loop 202 along a sidewall of the case 102 for accommodating a stylus for the tablet 100. In addition, the case 102 may include cavities for accommodating various features of the tablet 100, such as the power button, volume rocker, and camera. As an example, the case 102 may include cavities 304 for accommodating a lanyard to keep the stylus fixed to the case 102.

Referring to FIG. 1, the case 102 may include features 117 along a perimeter of the case 102 to secure the tablet 100 while it is fitted to the case 102. The features 117 may allow for users to “snap” the case 102 onto the tablet 100. As an example, the features along the perimeter of the case 102 may make contact with at least the left and right sidewalls of the tablet 100. In addition, the corners of the case 102 may include features 119 that prevent vertical displacement of the tablet 100 while it is fitted to the case 102. As an example, the case 102 may have a size and shape in accordance with the back surface 105 of the tablet 100. The case 102 may be composed of a rigid or semi-rigid material in order to provide a level of sturdiness and rigidity while protecting the back surface 105 of the tablet 100. Examples of materials that may be used for the case 102 include, but are not limited to, plastics, fiber glass, carbon fiber composites, and metals.

Referring to FIG. 2A, the case 102 may enclose at least the left and right sidewalls of the tablet 100 (e.g., via features 117). The bottom sidewall 107 (a first sidewall) may be exposed due to an opening 104 in the case 102. In addition, a portion of the back surface 105 adjacent to the bottom sidewall 107 may be exposed, as illustrated. As an example, the exposed portion of the back surface 105 may be continuous and extend from the bottom sidewall 107. Referring to FIG. 2A, the opening 104 or cutout may be U-shaped, but is not limited to the illustrated shape. As illustrated, a width of the opening 104 for exposing the back surface 105 of the tablet 100 may be less than a width of the tablet 100. As a result, portions of the back surface 105 adjacent to the exposed portions may be protected by the case 102 of the protective cover 115. The case 102 may have a thickness that is sufficient to protect the tablet 100, for example, by absorbing any impact from an accidental drop of the tablet 100. In addition, the thickness of the case 102 may be sufficient to protect even the portions of the tablet 100 exposed by the opening 104. In addition, the second portion 112 of the protective cover 115 may wrap around a second sidewall (top sidewall 109) of the tablet 100 opposite the bottom sidewall 107 to protect the display surface 103 of the tablet 100 when the tablet 100 is not in use. FIG. 2A illustrates segments 114, 116, 118 of the second portion 112 folded with respect to each other.

FIG. 2B illustrates the tablet 100 docked to a docking station 210 for the tablet 100, while the tablet 100 is enclosed by the case 102 of the protective cover 115, according to an example. As an example, the docking station 210 may include a connector and guide pins to electrically couple the docking station 210 with the tablet 100 when the connector is to connect with a port of the tablet 100. Referring to FIG. 2A, port 205 and a pair of cavities 207 on the bottom sidewall 107 of the tablet 100 may be used to accommodate the connector and guide pins of the docking station 210. As an example, the port 205 of the tablet 100 may be a common port used for other various purposes, such as for charging the tablet 100.

As described above, the docking station 210 may include various ports (e.g., USB, HDMI, etc.) to electrically couple with the tablet 100 when the tablet 100 is docked to the station 210. The opening 104 in the case 102 may allow for the tablet 100 to be docked to the docking station 210 without having to detach the case 102 from the tablet 100 prior to the docking. The opening 104 may allow for the exposed portion of the back surface 105 to make contact with the docking station 210. The docking station 210 may include a support element 212 to support the tablet 100 at a viewing angle that is appropriate for users. The support element 212 may make contact with all or a portion of the exposed portion of the back surface 105. As illustrated in FIG. 2B, the support element 212 may occupy the entire portion left exposed via the opening 104, according to an example. With the ability to dock the tablet 100 without having to detach the protective cover 115, users may have a positive experience when transitioning from a portable use of the tablet 100 (e.g., employing the touchscreen on the display surface of the tablet computer for both viewing and input) to an expanded use, for example, via the docking station 210, all while having the tablet 100 protected via the protective cover 115.

Referring to FIG. 2B, the folded state of the second portion 112 may include a triangular structure, wherein the first and second segments 114, 120 may be folded one atop the other to create a magnetic attraction between magnetic members 132, 134 to form a first side of the triangular structure. The remaining two sides of the triangular structure may come from the remaining segments of the second portion 112 (e.g., segments 116, 118). As an example, magnetic member 132 disposed within segment 114 may magnetically couple with magnetic member 134 disposed within segment 120 when segment 114 is placed within proximity of segment 120. The magnetic members 132, 134 may assure proper alignment and positioning of the segments of the second portion 112 when the segments are folded with respect to each other to form the triangular structure. As a result, users may fold the second portion 112 in a desired and repeatable manner, such that the segments 114, 116, 118, 120 are consistently folded in a pre-determined position relative to one another. The arrangement of the magnetic members 132, 134 is not limited to what is illustrated. In addition, additional magnetic members may be used to form the triangular structure.

As illustrated in FIG. 2B, the second portion 112 may be folded around the top sidewall 109 of the tablet 100 in order for users to operate the tablet 100 and view content from the display surface 103 of the tablet 100. When the tablet 100 is not docked to the docking station 210, the foldable segments of the second portion 112 may be used to support the tablet 100 while it is fitted to the protective cover 115.

FIGS. 3A-B provide example illustrations of the folded state of the second portion 112 supporting the tablet 100 on a horizontal surface at angles suitable for viewing visual content presented on the display surface 103 of the tablet 100. Referring to FIG. 3A, the triangular structure may be used as a keyboard support, for example, when users use the on-screen keyboard illustrated on the display surface 103 for entering characters. Referring to FIG. 3B, the triangular structure may be used as a stand onto which the tablet 100 may be placed such that visual content from the display surface 103 can be displayed at an angle suitable for users.

As an example, when the tablet 100 is not in use, the tablet 100 may include a magnetic member 332 disposed within the tablet 100 to cooperatively interact with a magnetic member disposed within the second portion 112 of the protective cover 115 (e.g., magnetic member 132), in order to ensure that the second portion 112 remains closed to protect the display surface 103 of the tablet 100. As an example, the magnetic member 332 can include a Hall Effect sensor for detecting the presence of a magnetic field, for example, the magnetic field generated when the magnetic member 132 is placed within proximity of the Hall Effect sensor. The Hall Effect sensor can respond to the presence (or absence) of the magnetic field by generating a signal. The signal can be used to alter an operating state of the electronic device. As an example, when the second portion 112 of the protective cover 115 is placed on or in proximity to the display surface 103 of the tablet 100, the Hall Effect sensor may generate a signal, which can be used to put the tablet 100 in standby mode. When the second portion 112 is removed from the display surface 103, to the point where the Hall Effect sensor no longer responds to the magnetic field of magnetic member 132, the Hall Effect sensor may generate another signal, which can be used to wake the tablet 100 from standby mode.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is clamed is:

1. A protective cover for a portable computing device including a display surface and a back surface opposite the display surface, the protective cover comprising:
a first portion including a case for enclosing the back surface and sidewalls of the device, wherein the case includes an opening for exposing a portion of the device comprising a first sidewall and a portion of the back surface adjacent to the first sidewall; and
a second portion pivotally connected to the first portion, wherein the second portion is to wrap around a second sidewall of the device opposite the first sidewall to protect the display surface of the device when the device is not in use.

2. The protective cover of claim 1, wherein a width of the opening for exposing the portion of the back surface is less than a width of the device.

3. The protective cover of claim 1, wherein the portion of the back surface makes contact with a docking station for the device when the device enclosed by the case is docked to the docking station.

4. The protective cover of claim 1, wherein the second portion of the protective cover comprises a plurality of independently foldable segments comprising a first segment at a first side of the second portion and a second segment at a second side of the second portion opposite the first side, wherein the plurality of independently foldable segments fold with respect to each other to form a folded state of the second portion.

5. The protective cover of claim 4, wherein the second portion of the protective cover comprises a third segment disposed between the first segment and the second segment.

6. The protective cover of claim 5, wherein the folded state of the second portion comprises a triangular structure comprising the first and second segments folded one atop the other to create a magnetic attraction between magnetic members disposed within the first and second segments to form a first side of the triangular structure.

7. The protective cover of claim 6, wherein the triangular structure is to support the portable computing device on a horizontal surface at an angle suitable for viewing visual content presented on the display surface of the device.

8. A protective cover for a portable computing device including a display surface and a back surface opposite the display surface, the protective cover comprising:
a first portion including a case for enclosing the back surface and sidewalls of the device, wherein the case includes an opening for exposing a portion of the device comprising a first sidewall and a portion of the back surface extending from the first sidewall; and
a second portion pivotally connected to the first portion, wherein the second portion is to wrap around a second sidewall of the device opposite the first sidewall to protect the display surface of the device when the device is not in use.

9. The protective cover of claim 8, wherein a width of the opening for exposing he portion of the back surface is less than a width of the device.

10. The protective cover of claim 8, wherein the portion of the back surface makes contact with a docking station for the device when the device enclosed by the case is docked to the docking station.

11. The protective cover of claim 8, wherein the second portion of the protective cover comprises a plurality of independently foldable segments comprising a first segment at a first side of the second portion and a second segment at a second side of the second portion opposite the first side, wherein the plurality of independently foldable segments fold with respect to each other to form a folded state of the second portion.

12. A system, comprising:
a portable computing device including a display surface and a back surface opposite the display surface; and
a protective cover for the device, comprising:
a first portion including a case for enclosing the back surface and sidewalls of the device, wherein the case includes an opening for exposing a portion of the device comprising a first sidewall and a portion of the back surface adjacent to the first sidewall; and
a second portion pivotally connected to the first portion, wherein the second portion is to wrap around a second sidewall of the device opposite the first sidewall to protect the display surface of the device when the device is not in use.

13. The system of claim 12, wherein a width of the opening for exposing the portion of the back surface is less than a width of the device.

14. The system of claim 12, wherein the portion of the back surface makes contact with a docking station for the device when the device enclosed by the case is docked to the docking station.

15. The system of claim 12, wherein the second portion of the protective cover comprises a plurality of independently foldable segments comprising a first segment at a first side of the second portion and a second segment at a second side of the second portion opposite the first side, wherein the plurality of independently foldable segments fold with respect to each other to form a folded state of the second portion.
